(19) United States
(12) Patent Application Publication
(10) Pub. No.: US 2025/0111395 A1
(43) Pub. Date: Apr. 3, 2025

(54) METHOD OF COLLECTING CONSUMER FEEDBACK IN THE METAVERSE

(71) Applicant: FIRST INSIGHT, INC., Warrendale, PA (US)

(72) Inventors: Gregory J. PETRO, Wexford, PA (US); Mangal ANANDAN, Mars, PA (US)

(21) Appl. No.: 18/904,649

(22) Filed: Oct. 2, 2024

Related U.S. Application Data
(60) Provisional application No. 63/542,015, filed on Oct. 2, 2023.

(51) Int. Cl. G06Q 30/0203; G06F 3/04815

(52) U.S. Cl. CPC G06Q 30/0203; G06F 3/04815

(57) ABSTRACT

A system, method, and computer program product for collecting consumer feedback in a metaverse. An example aspect is configured to: present a user with at least two or more products or services while the user is visiting a storefront in the metaverse, collect opinion data about the at least two or more products or services in the storefront in the metaverse, and performing analysis on the opinion data.

### CROSS-REFERENCE TO RELATED APPLICATIONS

This application claims priority of U.S. Patent Application No. 63/542,015 filed on Oct. 2, 2023, which is hereby incorporated by reference in its entirety.

### FIELD OF THE INVENTION

This disclosure generally relates to the field of collecting consumer feedback and data in a virtual environment.

### BACKGROUND

The term metaverse describes a fully immersive 3-dimensional virtual space, including a virtual environment wherein humans are represented by an avatar. Thus, users may interact with other users, both socially and economically, through their respective avatars and with software agents in a cyber space. The virtual environment in the metaverse does not have the physical limitations of the real world. In metaverse applications, users may have friends, create groups, talk and interact with strangers, fly, and teleport.

The number of users of metaverses has rapidly expanded. Anyone in the world can access the metaverse from anywhere in the world. Retail in the metaverse has been rapidly expanding with long-term virtual storefronts, pop-up virtual stores, or customer events. The metaverse allows for global reach wherein millions of global users may take part at the same time.

The metaverse allows for integrated commerce wherein entities may display products or services and immediately facilitate a sale. The metaverse is a medium where consumers may interact with brands in an entirely virtual environment and may be more inclined to provide feedback. However, traditional methods of consumer feedback are ineffective. As consumers and users spend more time online and the interest in metaverse applications continues to exponentially grow, companies need new methods of collecting and analyzing consumer feedback and data in a virtual environment.

Currently, companies struggle to deliver experiential personalization since traditional methods of collecting consumer feedback do not adequately translate to the virtual environment in the metaverse.

Accordingly, there is a need for an improved method of collecting consumer feedback in the metaverse that maximizes product or service potential and return of investment.

### BRIEF SUMMARY

The methods and systems of the present disclosure enable the collection and analysis of consumer feedback in the metaverse.

The presently disclosed methods and systems present a user with at least two or more products or services while the user is visiting a virtual storefront, collect opinion data about the at least two or more products or services, and perform analysis on the opinion data.

The methods and systems of the present disclosure may collect personal data and digital identity data about the user in the metaverse.

The methods and systems may facilitate interactions between metaverse avatars, entities, companies, products, services, or any combination thereof.

The presently disclosed methods and systems may be embodied as a system, method, or computer program product embodied in any tangible medium of expression having computer useable program code embodied in the medium.

### DESCRIPTION OF THE DRAWINGS

It is to be understood that both the foregoing summary and the following drawings and detailed description may be exemplary and may not be restrictive of the aspects of the present disclosure as claimed. Certain details may be set forth in order to provide a better understanding of various features, aspects, and advantages of the present disclosure. However, one skilled in the art will understand that these features, aspects, and advantages may be practiced without these details. In other instances, well-known structures, methods, and/or processes associated with methods of practicing the various features, aspects, and advantages may not be shown or described in detail to avoid unnecessarily obscuring descriptions of other details of the present disclosure.

The present disclosure may be better understood by reference to the accompanying drawing sheets, in which:

FIG. 1 is a flow chart of a method for collecting consumer feedback in the metaverse, in accordance with certain aspects of the present disclosure.

FIG. 2 is a schematic diagram of a computer network system for collecting consumer feedback in the metaverse, in accordance with certain aspects of the present disclosure.

FIG. 3 is a block diagram that schematically illustrates a system of a client computer, in accordance with certain aspects of the present disclosure.

### DETAILED DESCRIPTION

This disclosure generally describes methods and systems for collecting and analyzing consumer feedback in a metaverse.

A metaverse is a virtual-reality space or environment in which users can interact with a computer-generated environment and other users, entities, and objects. A metaverse may be a virtual world that may comprise any type of virtual economy, including but not limited to, a video game, a virtual world, a simulation, and the like. A metaverse may be interacted with through virtual reality (VR), augmented reality (AR), as well as 2-dimensional displays and 3-dimensional simulations. Information in a metaverse may be stored on a blockchain for security and non-falsifiability, for example to confirm that a virtual product or service is authentic. A metaverse server includes, but is not limited to, Second Life®, The Sandbox, Axie Infinity, Decentraland, Roblox, and any other metaverse server that serves a virtual world simulation, or metaverse, through a software application that may be stored and executed on a computer system.

While methods, systems, and computer program products of the present disclosure may be best explained within the context of metaverses, they may also be used in other contexts such as augmented reality experiences, virtual reality experiences, digital lands, digital product advertising, and other digital experiences.

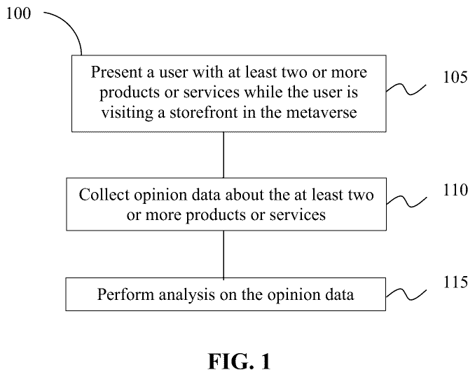

FIG. 1 depicts a flowchart of a method 100 for collecting consumer feedback in the metaverse in accordance with the present disclosure. A user is presented with at least two or more products or services while the user is visiting a virtual storefront in a metaverse server 105. While the user is visiting the virtual storefront, opinion data may be collected about the at least two or more products or services 110. The method 100 then performs analysis on the opinion data 115.

The products and services of the present disclosure may comprise a product or service that has been previously released by a company or entity, an unreleased product or service by a company or entity, a successful product or service, an unsuccessful product or service, or any combination thereof. Each product or service described above may be presented to a user in a virtual storefront. The at least two products or services may comprise products or services existing only in the metaverse, products or services existing only in the real world, products or services existing in both the metaverse and the real world, or any combination thereof.

A successful or unsuccessful product may be determined by the type of product or service, the brand, and/or by metrics, including, but not limited to, full price sales, gross margin, paid traffic, organic traffic, customer satisfaction score, customer lifetime value, conversion rate, cost per acquisition, and net promoter score.

Collecting opinion data regarding the at least two or more products or services in the storefront 110 includes, but is not limited to, asking a user to rate the at least two or more products or services on a scale, asking a user to indicate which, if any, of the at least two or more products or services the user would put in a virtual storefront for sale, asking a user to indicate a perceived monetary value of the at least two or more products or services, or any combination thereof. The user may be asked to rate the at least two or more products or services on a scale of 1 to 10, 1 to 20, 1 to 100 or any reasonably desired scale. Perceived monetary value may include the at least two or more products or services perceived monetary value in virtual currency, such as Bitcoin, Ethereum, Tether (USDT), USD Coin (USDC), Dogecoin (DOGE), and BNB. Perceived monetary value may also include real world currency such as United States Dollar, Euro, Pound sterling, Australian dollar, Canadian dollar, Swiss franc, Japanese yen, and Indian Rupee.

After collecting opinion data regarding the at least two or more products or services in the storefront 110, the method 100 may perform analysis on the opinion data 115. Performing analysis on the opinion data 115 may include weighting the opinion data of an unreleased product or service according to a correlation of the opinion data for a previously released product or service to a commercial success value of the previously released product or service. For example, the method 100 may present a user with at least one unreleased product or service (i.e., a product or service that has not been released to the public) and a previously released product or service 105. The method 100 then collects opinion data regarding both the unreleased product or service and the previously released product or service 110. The method 100 performs analysis on the opinion data 115 by correlating the opinion data of the previously released product to a commercial success value of the previously released product or service. After the correlation has been determined, the method 100 weights the opinion data of the unreleased product or service to the correlation.

The previously released product or service may comprise a successful product or service and an unsuccessful product or service. The opinion data of an unreleased product or service from users who were more aligned with the commercial success of the previously released products or services may be given higher weighting, while the opinion data of an unreleased product or service from users who were less aligned with the commercial success of the previously released products or services may be given a lower weighting. If the weighted opinion data for the unreleased product or service is high, then the method 100 may determine that the unreleased product or service has positive consumer feedback and positive commercial potential. If the weighted opinion data for the unreleased product or service is low, then the method 100 may determine that the unreleased product or service has negative consumer feedback and negative commercial potential.

Weighted opinion data for an unreleased product or service may be represented by a Value Score. The Value Score may range from 1 to 10. A product or service with a value score of 7 to 10 is determined to be high, while a value score of 1 to 3 is determined to be low. A value score of 4 to 6 may be determined to be average.

In another aspect, if the previously released product or service comprises an unsuccessful product or service and the opinion data of the unreleased product or service collected by the methods and systems of the present disclosure is greater than the correlation of the opinion data for the previously released unsuccessful product or service, then the method 100 may determine that the unreleased product or service has positive consumer feedback and positive commercial potential. If the opinion data of the unreleased product or service is less than or equal to the correlation of the opinion data for the previously released unsuccessful product or service, then the method 100 may determine that the unreleased product or service has negative consumer feedback and negative commercial potential.

The methods and systems of the present disclosure may present to a user a plurality of previously released successful products or services, a plurality of previously released unsuccessful products or services, a plurality of unreleased products or services, or any combination thereof.

The at least two products or services according to the methods and systems of the present disclosure may be presented to a user as visual media, including but not limited to, 2-dimensional and 3-dimensional media, audio formats, haptic interfaces, or any combination thereof.

The method 100 may further comprise collecting personal data about the user. The method 100 may collect data regarding the digital identity of the user in the metaverse and a user profile in the metaverse. The method 100 may utilize the personal data and digital identity data to verify the user is a real human. The method 100 may collect personal data about the digital identity of the user by collecting data regarding digital assets, which include but are not limited to, avatar information, avatar “skin”, articles of apparel, articles of footwear, weapons, or other digitally represented assets within a metaverse. While the digital asset may have its existence within the metaverse, its unique existence may be individually secured to a distributed blockchain ledger in the form of a non-fungible cryptographic token (NFT). This NFT may be associated with a digital wallet belonging to, or otherwise accessible by the owner of the asset (the user). During the course of the digital asset's life or existence, the asset may be capable of receiving various “upgrades,” such as upgraded functionality, altered visual appearance, dynamic overlays, advertising indicia, and the like. Thus, the methods and systems of the present disclosure may determine the digital identity and collect personal data about a user by accessing the public address and distributed blockchain ledger of the user. It should be appreciated that the above-described technology may be capable of implementation in a variety of forms. While NFT technology is referenced, the technology may be implemented through one or more public blockchains, private blockchains, and/or may incorporate one or more sidechains, smart contracts, databases, and the like.

The method 100 may analyze a user's public blockchain address including but not limited to, any smart contracts and databases, to collect data regarding the user's digital identity such as, all NFTs owned, digital asset balances, transaction prices, time of transactions, and any other pertinent information that may be found within the public blockchain, smart contract, sidechains, private blockchains, or other databases.

The method 100 may collect personal data of the user, wherein personal data includes, but is not limited to, age, demographic, behavioral, gender, and location data, or any combination thereof. Behavioral data includes any data generated by, or in response to, a user's engagement with a virtual storefront. This includes, but is not limited to, amount of time a user is in a virtual storefront, number of virtual storefront visits, number of purchases in a virtual storefront, amount of money spent in a virtual storefront, items added to a shopping cart in a virtual storefront, and/or any other user event that may be of interest in a virtual storefront. Since a user in a metaverse may remain completely anonymous and only identifiable by public blockchain addresses, the method 100 may collect personal data of the user through question and answer with the user, wherein the user may voluntarily provide responses.

The method may also collect biometric data such as eye position and bodily movements. The method may also collect biometrically inferred data (BID), wherein the BID is inferred from behavioral, physical, psychological and other non-verbal communication methods wherein AI-based predictive modeling techniques may be utilized to create biometrically inferred data sets.

The method may use the personal data and/or the data regarding the user's digital identity to analyze the opinion data collected of the at least two products or services. The method may further analyze the opinion data collected of the at least two products or services according to users within a subset of the opinion data. For example, the method may use age data to analyze the opinion data of the at least two products or services according to opinion data collected from users within certain timeframes, such as from 5 pm to 9 pm or 8 am to 12 am. Thus, the method may use the personal data and/or digital identity data to analyze the at least two products or services according to different subsets of opinion data, which enables more specific collection and specialized analysis of consumer feedback in a metaverse.

The methods and systems of the present disclosure may facilitate interactions between metaverse avatars, entities, products, and services. The method may direct a user to a specific location in a virtual storefront to provide opinion data about the at least two products or services located in the specific location. The method may direct a user to interact with a product or service or a plurality of products or services located in a storefront and collect opinion data regarding the user's interaction with the product or service or plurality of products or services. The method may direct a user to interact with a second user or a plurality of users and collect opinion data regarding the products or services involved in any interaction. The method may direct a user to provide opinion data regarding the layout and design of a virtual storefront. The method may further collect opinion data regarding a user's opinion of an entity when the user enters an entity's virtual storefront. The method may show a user advertisements, promotions, or giveaways offered by an entity.

Not every entity may have a virtual storefront in a metaverse. Thus, the methods and systems of the presently disclosure may create a virtual storefront in the metaverse. The method may make the storefront available to a user and populate at least two or more products or services in the storefront. The method may invite users to the created virtual storefront in order to enable the methods and systems of the present disclosure.

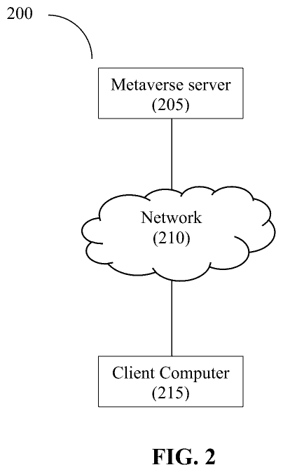

FIG. 2 depicts a schematic diagram of a computer network system 200 of the present disclosure. The computer network system 200 may interface a system user and a metaverse server 205 according to the interface operations of the client computer 215. Although the depicted computer network system 200 is shown and described herein with certain components and functionality, other embodiments of the computer network system 200 may be implemented with fewer or more components or with less or more functionality. For example, some aspects of the computer network system 200 may include a plurality of metaverse servers 205 and a plurality of networks 210. Some aspects of the computer network system 5 may include similar components arranged in another manner to provide similar functionality in one or more aspects.

The client computer 215 manages the interface between a system user and the metaverse server 205. In one aspect, the client computer 215 is a mobile computer device that allows a user to connect to and interact with a metaverse. In some aspects, the client computer 215 is a video game console. The client computer 215 may be connected to the metaverse server 205 via a local area network (LAN) or other network 210.

Although the present disclosure is described with regard to a “computer”, it should be noted that optionally any device featuring a data processor and the ability to execute one or more instructions may be described as a computer, including but not limited to any type of personal computer (PC), a server, a distributed server, a virtual server, a cloud computing platform, a cellular telephone, an IP telephone, a smartphone, a mobile device, or a personal digital assistant (PDA). Any two or more of such devices in communication with each other may optionally comprise a network or a computer network.

The metaverse server 205 hosts a simulated virtual world, or a metaverse, for a plurality of client computers 215. The metaverse server 205 may be an array of servers. In one aspect, a specified area of the metaverse is simulated by a single server instance, and multiple server instances may be run on a single metaverse server 205. In some aspects, the metaverse server 205 includes a plurality of simulation servers dedicated to physics simulation to manage interactions and handle collisions between characters and objects in a metaverse. The metaverse server 205 may include a plurality of storage servers, apart from the plurality of simulation servers, dedicated to storing data related to objects and characters in the metaverse world. The data stored on the plurality of storage servers may include object shapes, avatar shapes and appearances, audio clips, metaverse related scripts, and other metaverse related objects.

The network 210 may communicate traditional block I/O, for example, over a storage area network (SAN). The network 210 may also communicate file I/O, for example, using a transmission control protocol/internet protocol (TCP/IP) network or similar communication protocol. In one aspect, the storage system includes two or more networks. In another aspect, the client computer 215 is connected directly to a metaverse server 205 via a backplane or system bus. In one aspect, the network 210 includes a cellular network, other similar types of networks, or combinations thereof.

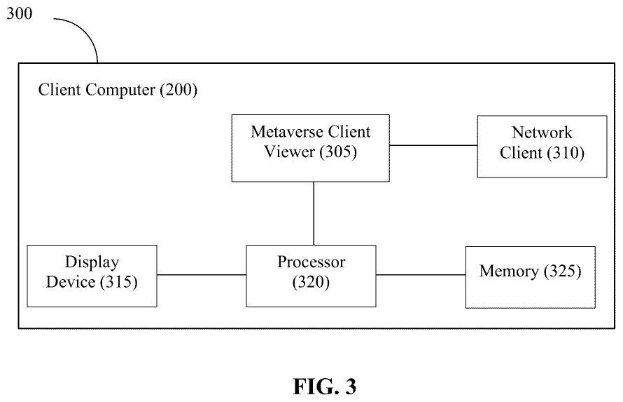

FIG. 3 is a block diagram that schematically illustrates a system 300 of a client computer 200 capable of executing the methods of the present disclosure. The client computer 8 may comprise a metaverse client viewer 305, a display device 315, a processor 320 that interfaces with memory 325 (which may be separate from or included as part of processor 320), and a network client 310. In some aspects, the client computer may comprise at least one bus interfaces. Although the presently depicted client computer 200 is shown and described herein with certain components and functionality, other aspects of the client computer 200 may be implemented with fewer or more components with less or more functionality.

The metaverse client viewer 305 may be stored as computer readable instructions in memory 325 or a data storage device within a client computer 200. Alternatively, the metaverse client viewer 305 may be implemented independently of the various components of the client computer 200. The metaverse client viewer 305 may be a client program executed on a client computer wherein the metaverse client viewer 305 enables a user on a client computer 200 to interact with other users on other client computers 200 that are also connected to the metaverse server 205.

The computer system 300 of FIG. 3 comprises at least one or more non-transitory computer-readable storage devices for execution of program instructions by at least one or more processors 320 by at least one or more computer-readable memories 325. The program instructions comprise instructions to perform the methods of collecting consumer feedback in the metaverse described herein. The program instructions comprise presenting a user with at least two or more products or services while the user is visiting a storefront in a metaverse, collecting opinion data about the at least two or more products or services in the storefront, and analyzing the opinion data.

The display device 315 may include, but is not limited to, a graphical display such as a cathode ray tube (CRT) monitor, a liquid crystal display (LCD) monitor, or another type of display device. The display device 315 may be configured to convey a visual representation of a metaverse virtual world, as well as control and configuration tools to control and configure aspects of methods of collecting consumer feedback in a metaverse discussed above in further detail.

Processor 320 may be a central processing unit (CPU) with one or more processing cores, a graphical processing unit (GPU), or another type of processing device such as a general purpose processor, an application specific processor (ASIC), a multi-core processor, a microprocessor, or other suitable processing device that interfaces with memory 325. The processor 320 executes instructions to provide operational functionality to the computer network system 200 and to complete and facilitate the methods described herein. The instructions may be stored locally in the processor 320 or in the memory 325. The memory 325 may also employ cloud-based memory. In one aspect, the system may connect to a base station that includes memory and processing capabilities.

The client computer 200 may further comprise an I/O device.

The I/O device (including, but not limited to, keyboards, displays, pointing devices, DASD, tape, CDs, DVDs, thumb drives and other memory media, etc.) may be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards may be just a few of the available types of network adapters.

As will be appreciated by one skilled in the art, the present disclosure may be embodied as a system, method, or computer program product. Accordingly, the present disclosure may take the form of an entirely hardware aspect, an entirely software aspect (including firmware, resident software, micro-code, etc.), or an aspect combining software and hardware aspects that may all generally be referred to herein as a “system.” Furthermore, the present disclosure may take the form of a computer program product embodied in any tangible medium of expression having computer useable program code embodied in the medium.

Any combination of one or more computer useable or computer readable medium(s) may be utilized. The computer-useable or computer-readable medium may be, for example but not limited to, an electronic, magnetic, optical, electromagnetic, infrared, or semiconductor system, apparatus, device, or propagation medium. Computer-readable medium may also be an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, a magnetic storage device, a digital versatile disk (DVD), a memory stick, a floppy disk, a mechanically encoded device such as punch-cards or raised structures in a groove having instructions recorded thereon, and any suitable combination of the foregoing. Note that the computer-useable or computer-readable medium may be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-useable or computer-readable medium may be any medium that can contain, store, communicate, propagate, or transport the program for use by or in connection with the instruction execution system, apparatus, or device. The computer-useable program code may be transmitted using any appropriate medium, including but not limited to wireless, wireline, optical fiber cable, RF, etc.

Computer program code for carrying out operations of the presently disclosed invention may be written in any combination of one or more programming languages. The programming language may be, but is not limited to, object-oriented programming languages (Java, Smalltalk, C++, etc.) or conventional procedural programming languages (“C” programming language, etc.). The program code may execute entirely on a user's computer, partly on the user's computer, as a stand-alone software package, partly on a user's computer and partly on a remote computer, or entirely on the remote computer or server. In the latter scenario, the remote computer may be connected to the user's computer through any type of network, including a local area network (LAN) or a wide area network (WAN), or the connection may be made to an external computer, which may include through the Internet using an Internet Services Provider. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The systems and methods of the present disclosure may process data on any commercially available computer. In other aspects, a computer operating system may include, but is not limited to MAC OS, IOS, Android, Ubuntu, Linux, Windows, or UNIX. In one aspect of the present disclosure, the forgoing processing devices or any other electronic, computation platform of a type designed for electronic processing of digital data as herein disclosed may be used.

Aspects of the present disclosure are described with reference to flowchart illustrations and/or block diagrams of methods, systems, and computer program products according to aspects of the present disclosure. It will be understood that each block of the flowchart illustrations and/or block diagrams, and combination of blocks in the flowchart illustrations and/or block diagrams, may be implemented by computer program instructions. These computer program instructions may be provided to a processor of a general purpose computer, special purpose computer, or other programmable data processing apparatus to produce a machine, which the instructions execute via the processor of the computer or other programmable data processing apparatus allowing for the implementation of the steps specified in the flowchart and/or block diagram blocks or blocks.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others.

### Definitions

Unless otherwise defined, all terms (including technical and scientific terms) used herein have the same meaning as commonly understood by one of ordinary skill in the art to which this disclosure belongs. As such, terms, such as those defined by commonly used dictionaries, should be interpreted as having a meaning that is consistent with their meaning in a context of a relevant art and should not be interpreted in an idealized or overly formal sense unless expressly so defined herein.

As used herein, the term “entity” refers to any company, institution, establishment, organization, corporation, or business capable of selling a product or service in a metaverse.

A blockchain or blockchain is a distributed database that maintains a list of data records, the security of which is enhanced by the distributed nature of the blockchain. A blockchain typically includes several nodes, which may be one or more systems, machines, computers, databases, data stores or the like operably connected with one another. In some cases, each of the nodes or multiple nodes are maintained by different entities. A blockchain typically works without a central repository or single administrator. One well-known application of a blockchain is the public ledger of transactions for cryptocurrencies such as used in bitcoin. The data records recorded in the blockchain are enforced cryptographically and stored on the nodes of the blockchain.

The blockchain typically has two primary types of records. The first type is the transaction type, which consists of the actual data stored in the blockchain. The second type is the block type, which are records that confirm when and in what sequence certain transactions became recorded as part of the blockchain. Transactions are created by participants using the blockchain in its normal course of business, for example, when someone sends cryptocurrency to another person), and blocks are created by users known as “miners” who use specialized software/equipment to create blocks. Users of the blockchain create transactions that are passed around to various nodes of the blockchain. A “valid” transaction is one that can be validated based on a set of rules that are defined by the particular system implementing the blockchain. For example, in the case of cryptocurrencies, a valid transaction is one that is digitally signed, spent from a valid digital wallet and, in some cases, that meets other criteria. In some blockchain systems, miners are incentivized to create blocks by a rewards structure that offers a pre-defined per-block reward and/or fees offered within the transactions validated themselves. Thus, when a miner successfully validates a transaction on the blockchain, the miner may receive rewards and/or fees as an incentive to continue creating new blocks.

Smart contracts are computer processes that facilitate, verify and/or enforce negotiation and/or performance of a contract between parties. One fundamental purpose of smart contracts is to integrate the practice of contract law and related business practices with electronic commerce protocols between people on the Internet. Smart contracts may leverage a user interface that provides one or more parties or administrators access, which may be restricted at varying levels for different people, to the terms and logic of the contract. Smart contracts typically include logic that emulates contractual clauses that are partially or fully self-executing and/or self-enforcing. Examples of smart contracts are digital rights management (DRM) used for protecting copyrighted works, buying or selling goods, whether or virtual or physical, executing transfers of goods or of rights associated with such goods, and the like.

Smart contracts may also be described as pre-written logic (computer code), stored and replicated on a distributed storage platform (e.g. a blockchain), executed/run by a network of computers (which may be the same ones running the blockchain), which can result in ledger updates (transfer of digital rights, etc.).

Smart contract infrastructure can be implemented by replicated asset registries and contract execution using cryptographic hash chains and Byzantine fault tolerant replication. For example, each node in a peer-to-peer network or blockchain distributed network may act as a title registry and escrow, thereby executing changes of ownership and implementing sets of predetermined rules that govern transactions on the network. Each node may also check the work of other nodes and in some cases, as noted above, function as miners or validators.

Not all blockchains can execute all types of smart contracts. For example, Bitcoin cannot currently execute smart contracts. Sidechains, i.e. blockchains connected to Bitcoin's main blockchain could enable smart contract functionality: by having different blockchains running in parallel to Bitcoin, with an ability to jump value between Bitcoin's main chain and the side chains, side chains could be used to execute logic. Smart contracts that are supported by sidechains are contemplated as being included within the blockchain enabled smart contracts that are described below.

As used herein, the term “and/or” includes any and all combinations of one or more of the associated listed items. Likewise, as used in the following detailed description, the term “or” is intended to mean an inclusive “or” rather than an exclusive “or.” That is, unless specified otherwise, or clear from context, “X employs A or B” is intended to mean nay of the natural inclusive permutations. Thus, if X employs A; X employs B; or X employs both A and B, then “X employs A or B” is satisfied under any of the foregoing instances.

The terminology used herein is for the purpose of describing particular examples only and is not intended to be limiting. As used herein, the singular forms “a”, “an”, and “the” may be intended to include the plural forms as well, unless the context clearly dictates otherwise. As example, “a” machine part may comprise one or more parts, and the like.

The terms “comprises”, “comprising”, “including”, “having”, and “characterized by”, may be inclusive and therefore specify the presence of stated features, elements, compositions, steps, integers, operations, and/or components, but do not preclude the presence or addition of one or more other features, integers, steps, operations, elements, components, and/or groups thereof. Although these open-ended terms may be to be understood as a non-restrictive term used to describe and claim various aspects set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, described herein also specifically includes embodiments consisting of, or consisting essentially of, such recited compositions, materials, components, elements, features, integers, operations, and/or process steps. In the case of “consisting of”, the alternative embodiment excludes any additional compositions, materials, components, elements, features, integers, operations, and/or process steps, while in the case of “consisting essentially of”, any additional compositions, materials, components, elements, features, integers, operations, and/or process steps that materially affect the basic and novel characteristics may be excluded from such an embodiment, but any compositions, materials, components, elements, features, integers, operations, and/or process steps that do not materially affect the basic and novel characteristics may be included in the embodiment.

Any method steps, processes, and operations described herein may not be construed as necessarily requiring their performance in the particular order discussed or illustrated, unless specifically identified as an order of performance. It is also understood that additional or alternative steps may be employed, unless otherwise indicated.

In addition, features described with respect to certain example embodiments may be combined in or with various other example embodiments in any permutational or combinatory manner. Different aspects or elements of example embodiments, as disclosed herein, may be combined in a similar manner. The term “combination”, “combinatory,” or “combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included may be combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Aspects of the present disclosure may be described herein with reference to flowchart illustrations and/or block diagrams of methods, apparatus (systems), and computer program products according to aspects of the disclosure. It will be understood that each block of the flowchart illustrations and/or block diagrams, and combinations of blocks in the flowchart illustrations and/or block diagrams, may be implemented by computer readable program instructions. The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the Figures illustrate the architecture, functionality, and operation of possible implementations of systems, methods, and computer program products according to various aspects of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

Words such as “then,” “next,” etc. are not intended to limit the order of the steps; these words may be simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

In the description, certain details are set forth in order to provide a better understanding of various embodiments of the systems and methods disclosed herein. However, one skilled in the art will understand that these embodiments may be practiced without these details and/or in the absence of any details not described herein. In other instances, well-known structures, methods, and/or techniques associated with methods of practicing the various embodiments may not be shown or described in detail to avoid unnecessarily obscuring descriptions of other details of the various embodiments.

While specific aspects of the disclosure have been provided hereinabove, the disclosure may, however, be embodied in many different forms and should not be construed as necessarily being limited to only the embodiments disclosed herein. Rather, these embodiments may be provided so that this disclosure is thorough and complete, and fully conveys various concepts of this disclosure to skilled artisans.

Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.”

All numerical ranges stated herein include all sub-ranges subsumed therein. For example, a range of “1 to 10” or “1-10” is intended to include all sub-ranges between and including the recited minimum value of 1 and the recited maximum value of 10 because the disclosed numerical ranges may be continuous and include every value between the minimum and maximum values. Any maximum numerical limitation recited herein is intended to include all lower numerical limitations. Any minimum numerical limitation recited herein is intended to include all higher numerical limitations.

Features or functionality described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, may be at least partially performed via at least one entity or actor in any manner.

All documents cited herein may be incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to this application.

While particular embodiments have been illustrated and described, it would be obvious to those skilled in the art that various other changes and modifications may be made without departing from the spirit and scope of the invention. Those skilled in the art will recognize or be able to ascertain using no more than routine experimentation, numerous equivalents to the specific apparatuses and methods described herein, including alternatives, variants, additions, deletions, modifications and substitutions. This application including the appended claims is therefore intended to cover all such changes and modifications that may be within the scope of this application.

### Aspects of the Present Disclosure

Aspect 1: A method of collecting consumer market research data in a metaverse, comprising: presenting a user with at least two or more products or services while the user is visiting a storefront in the metaverse; collecting opinion data about the at least two or more products or services in the storefront in the metaverse; and performing analysis on the opinion data.

Aspect 2: The method of claim 1, wherein the at least two or more products or services comprises a previously released product or service and an unreleased product or service.

Aspect 3: The method according to any of the foregoing aspects, wherein the previously released product or service comprises a successful product or service and an unsuccessful product or service.

Aspect 4: The method according to any of the foregoing aspects, wherein performing analysis on the opinion data comprises, weighting the opinion data of the unreleased product or service according to correlation of the opinion data for the previously released product or service to a commercial success value of the previously released product or service.

Aspect 5: The method according to any of the foregoing aspects, wherein performing analysis on the opinion data comprises, weighting the opinion data of the unreleased product or service according to a correlation of the opinion data of the successful and unsuccessful previously released product or service to a commercial success value of the successful and unsuccessful previously released product or service, respectively.

Aspect 6: The method according to any of the foregoing aspects, further comprising: collecting personal data about the user; and collecting data about the digital identity of the user in the metaverse and a user profile in the metaverse.

Aspect 7: The method according to any of the foregoing aspects, further comprising: using the personal data about the user to analyze the opinion data of the at least two products or services according to users within a subset of the opinion data.

Aspect 8: The method according to any of the foregoing aspects, wherein the personal data comprises age, demographic, behavioral, gender, and location data.

Aspect 9: The method according to any of the foregoing aspects, wherein the at least two products or services are presented to the user as visual media including 2D and 3D media, audio format, haptic interfaces or any combination thereof.

Aspect 10: The method according to any of the foregoing aspects, further comprising, facilitating interactions between metaverse avatars, entities, products, and services wherein the interactions include directing a user to a specific location in the storefront to provide opinion data about the at least two products or services.

Aspect 11: The method according to any of the foregoing aspects, wherein collecting opinion data about the at least two or more products or services in the storefront in the metaverse comprises, rating the at least two or more products or services on a scale, indicating the at least two or more products or services the user would put in a virtual storefront, indicating a perceived monetary value of the at least two or more products or services, or any combination thereof.

Aspect 12: The method according to any of the foregoing aspects, further comprising, creating a storefront in the metaverse; making the storefront available to the user; and populating the at least two or more products or services in the storefront.

Aspect 13: The method according to any of the foregoing aspects, wherein the at least two products or services comprise products or services existing only in the metaverse.

Aspect 14: The method according to any of the foregoing aspects, wherein the at least two products or services comprise products or services existing in the real word.

Aspect 15: The method according to any of the foregoing aspects, wherein the at least two products or services comprise products or services existing in both the metaverse and the real world.

Aspect 16: A computer system for collecting consumer market research data in a metaverse, the computer system comprising at least one or more non-transitory computer-readable tangible storage devices, one or more processors, one or more computer readable memories, and program instructions stored on the at least one or more non-transitory computer-readable tangible storage devices for execution by at least one of the one or more processors by at least one of the one or more computer-readable memories, the program instructions comprising: program instructions to present a user with at least two products or services while the user is visiting a storefront in the metaverse; program instructions to collect opinion data about the at least two or more products or services in the storefront in the metaverse; and program instructions to perform analysis on the opinion data.

Aspect 17: The computer system of aspect 16, wherein the at least two products or services comprises a previously released product or service and an unreleased product or service.

Aspect 18: The computer system according to any of the foregoing aspects, wherein the previously released product or service comprises a successful product or service and an unsuccessful product or service.

Aspect 19: The computer system according to any of the foregoing aspects, wherein program instructions to perform analysis on the opinion data comprises, program instructions to weight the opinion data of the unreleased product or service according to correlation of the opinion data for the previously released product or service to a commercial success value of the previously released product or service.

Aspect 20: The computer system according to any of the foregoing aspects, wherein program instructions to perform analysis on the opinion data comprises: program instructions to weight the opinion data of the unreleased product or service according to a correlation of the opinion data of the successful and unsuccessful previously released product or service to a commercial success value of the successful and unsuccessful previously released product or service, respectively.

Aspect 21: The computer system according to any of the foregoing aspects, further comprising: program instructions to collect personal data about the user; and program instructions to collect data about the digital identity of the user in the virtual universe and a user profile in the virtual universe.

Aspect 22: The computer system according to any of the foregoing aspects, further comprising: program instructions to use the personal data about the user to analyze the opinion data of the at least two products or services according to users within a subset of the opinion data.

Aspect 23: The computer system according to any of the foregoing aspects, wherein the personal data about the user comprises age, demographic, behavioral, gender, and location data.

Aspect 24: The computer system according to any of the foregoing aspects, wherein the at least two products are presented to the user as visual media including 2D and 3D media, audio format, haptic interfaces or any combination thereof.

Aspect 25: The computer system according to any of the foregoing aspects, further comprising, program instructions to facilitate interactions between metaverse avatars, entities, and products, wherein the interactions include directing a user to a specific location in a virtual storefront to provide opinion data about the at least two products.

Aspect 26: The computer system according to any of the foregoing aspects, wherein program instructions to collect opinion data about the at least two or more products or services in the storefront in the metaverse comprises rating at least two or more products or services on a scale, indicating which at least two or more products or services the user would put in a virtual storefront, indicating a perceived monetary value of the at least two or more products or services, or any combination thereof.

Aspect 27: The computer system according to any of the foregoing aspects, further comprising program instructions to create a storefront in the metaverse and to make the storefront available to the user, wherein the at least two or more products or services populate the storefront.

Aspect 28: The computer system according to any of the foregoing aspects, wherein the at least two products or services comprise products or services existing only in the metaverse.

Aspect 29: The computer system according to any of the foregoing aspects, wherein the at least two products or services comprise products or services existing in the real word.

Aspect 30: The computer system according to any of the foregoing aspects, wherein the at least two products or services comprise products or services existing in both the metaverse and the real world.

Aspect 31: A computer program product for collecting consumer market research data in a metaverse, comprising at least one non-transitory computer readable medium including program instructions that, when executed by at least one processor, cause said at least one processor to: present a user with at least two products or services while the user is visiting a storefront in the metaverse; collect opinion data about the at least two or more products or services in the storefront in the metaverse; and perform analysis on the opinion data.

Aspect 32: The computer program product of aspect 31, wherein the at least two products or services comprises a previously released product or service and an unreleased product or service.

Aspect 33: The computer program product according to any of the foregoing aspects, wherein the previously released product or service comprises a successful product or service and an unsuccessful product or service.

Aspect 34: The computer program product according to any of the foregoing aspects, wherein perform analysis on the opinion data comprises, program instructions to weight the opinion data of the unreleased product or service according to correlation of the opinion data for the previously released product or service to a commercial success value of the previously released product or service.

Aspect 35: The computer program product according to any of the foregoing aspects, wherein perform analysis on the opinion data comprises: program instructions to weight the opinion data of the unreleased product or service according to a correlation of the opinion data of the successful and unsuccessful previously released product or service to a commercial success value of the successful and unsuccessful previously released product or service, respectively.

Aspect 36: The computer program product according to any of the foregoing aspects, further comprising: program instructions to collect personal data about the user; and program instructions to collect data about the digital identity of the user in the virtual universe and a user profile in the virtual universe.

Aspect 37: The computer program product according to any of the foregoing aspects, further comprising: program instructions to use the personal data about the user to analyze the opinion data of the at least two products or services according to users within a subset of the opinion data.

Aspect 38: The computer program product according to any of the foregoing aspects, wherein the personal data about the user comprises age, demographic, behavioral, gender, and location data.

Aspect 39: The computer program product according to any of the foregoing aspects, wherein the at least two products are presented to the user as visual media including 2D and 3D media, audio format, haptic interfaces or any combination thereof.

Aspect 40: The computer program product according to any of the foregoing aspects, further comprising, program instructions to facilitate interactions between metaverse avatars, entities, and products, wherein the interactions include directing a user to a specific location in a virtual storefront to provide opinion data about the at least two products.

Aspect 41: The computer program product according to any of the foregoing aspects, wherein program instructions to collect opinion data about the at least two or more products or services in the storefront in the metaverse comprises rating at least two or more products or services on a scale, indicating which at least two or more products or services the user would put in a virtual storefront, indicating a perceived monetary value of the at least two or more products or services, or any combination thereof.

Aspect 42: The computer program product according to any of the foregoing aspects, further comprising program instructions to create a storefront in the metaverse and to make the storefront available to the user, wherein the at least two or more products or services populate the storefront.

Aspect 43: The computer program product according to any of the foregoing aspects, wherein the at least two products or services comprise products or services existing only in the metaverse.

Aspect 44: The computer program product according to any of the foregoing aspects, wherein the at least two products or services comprise products or services existing in the real word.

Aspect 45: The computer program product according to any of the foregoing aspects, wherein the at least two products or services comprise products or services existing in both the metaverse and the real world.

What is claimed is:

1. A method of collecting consumer market research data in a metaverse, comprising:
presenting a user with at least two or more products or services while the user is visiting a storefront in the metaverse;
collecting opinion data about the at least two or more products or services in the storefront in the metaverse; and
performing analysis on the opinion data.

2. The method of claim 1, wherein the at least two or more products or services comprises a previously released product or service and an unreleased product or service.

3. The method of claim 2, wherein the previously released product or service comprises a successful product or service and an unsuccessful product or service.

4. The method of claim 2, wherein performing analysis on the opinion data comprises, weighting the opinion data of the unreleased product or service according to correlation of the opinion data for the previously released product or service to a commercial success value of the previously released product or service.

5. The method of claim 3, wherein performing analysis on the opinion data comprises, weighting the opinion data of the unreleased product or service according to a correlation of the opinion data of the successful and unsuccessful previously released product or service to a commercial success value of the successful and unsuccessful previously released product or service, respectively.

6. The method of claim 1, further comprising:
collecting personal data about the user; and
collecting data about the digital identity of the user in the metaverse and a user profile in the metaverse.

7. The method of claim 6, further comprising:
using the personal data about the user to analyze the opinion data of the at least two products or services according to users within a subset of the opinion data.

8. The method of claim 6, wherein the personal data comprises age, demographic, behavioral, gender, and location data.

9. The method of claim 1, wherein the at least two products or services are presented to the user as visual media including 2D and 3D media, audio format, haptic interfaces or any combination thereof.

10. The method of claim 1, further comprising,
facilitating interactions between metaverse avatars, entities, products, and services wherein the interactions include directing a user to a specific location in the storefront to provide opinion data about the at least two products or services.

11. The method of claim 1, wherein collecting opinion data about the at least two or more products or services in the storefront in the metaverse comprises,
rating the at least two or more products or services on a scale, indicating the at least two or more products or services the user would put in a virtual storefront, indicating a perceived monetary value of the at least two or more products or services, or any combination thereof.

12. The method of claim 1, further comprising,
creating a storefront in the metaverse;
making the storefront available to the user; and
populating the at least two or more products or services in the storefront.

13. The method of claim 1, wherein the at least two products or services comprise products or services existing only in the metaverse.

14. The method of claim 1, wherein the at least two products or services comprise products or services existing in the real word.

15. The method of claim 1, wherein the at least two products or services comprise products or services existing in both the metaverse and the real world.

16. A computer system for collecting consumer market research data in a metaverse, the computer system comprising at least one or more non-transitory computer-readable tangible storage devices, one or more processors, one or more computer readable memories, and program instructions stored on the at least one or more non-transitory computer-readable tangible storage devices for execution by at least one of the one or more processors by at least one of the one or more computer-readable memories, the program instructions comprising:
program instructions to present a user with at least two products or services while the user is visiting a storefront in the metaverse;
program instructions to collect opinion data about the at least two or more products or services in the storefront in the metaverse; and
program instructions to perform analysis on the opinion data.

17. The computer system of claim 16, wherein the at least two products or services comprises a previously released product or service and an unreleased product or service.

18. The computer system of claim 17, wherein the previously released product or service comprises a successful product or service and an unsuccessful product or service.

19. The computer system of claim 17, wherein program instructions to perform analysis on the opinion data comprises,
program instructions to weight the opinion data of the unreleased product or service according to correlation of the opinion data for the previously released product or service to a commercial success value of the previously released product or service.

20. The computer system of claim 18, wherein program instructions to perform analysis on the opinion data comprises,
program instructions to weight the opinion data of the unreleased product or service according to a correlation of the opinion data of the successful and unsuccessful previously released product or service to a commercial success value of the successful and unsuccessful previously released product or service, respectively.

21. The computer system of claim 16, further comprising:
program instructions to collect personal data about the user; and
program instructions to collect data about the digital identity of the user in the virtual universe and a user profile in the virtual universe.

22. The computer system of claim 21, further comprising:
program instructions to use the personal data about the user to analyze the opinion data of the at least two products or services according to users within a subset of the opinion data.

23. The computer system of claim 21, wherein the personal data about the user comprises age, demographic, behavioral, gender, and location data.

24. The computer system of claim 16, wherein the at least two products are presented to the user as visual media including 2D and 3D media, audio format, haptic interfaces or any combination thereof.

25. The computer system of claim 16, further comprising,
program instructions to facilitate interactions between metaverse avatars, entities, and products, wherein the interactions include directing a user to a specific location in a virtual storefront to provide opinion data about the at least two products.

26. The computer system of claim 16, wherein program instructions to collect opinion data about the at least two or more products or services in the storefront in the metaverse comprises rating at least two or more products or services on a scale, indicating which at least two or more products or services the user would put in a virtual storefront, indicating a perceived monetary value of the at least two or more products or services, or any combination thereof.

27. The computer system of claim 16, further comprising
program instructions to create a storefront in the metaverse and to make the storefront available to the user, wherein the at least two or more products or services populate the storefront.

28. The computer system of claim 16, wherein the at least two products or services comprise products or services existing only in the metaverse.

29. The computer system of claim 16, wherein the at least two products or services comprise products or services existing in the real word.

30. The computer system of claim 16, wherein the at least two products or services comprise products or services existing in both the metaverse and the real world.
